(19) United States
(12) Patent Application Publication
(10) Pub. No.: US 2017/0054285 A1
(43) Pub. Date: Feb. 23, 2017

(54) PROTECTION APPARATUS FOR AN ELECTRICAL LOAD, VOLTAGE CONVERTER COMPRISING A PROTECTION APPARATUS, AND METHOD FOR PROTECTING AN ELECTRICAL LOAD

(71) Applicant: Robert Bosch GmbH, Stuttgart (DE)

(72) Inventor: Jiahang Jin, Muehlacker (DE)

(21) Appl. No.: 15/236,618

(22) Filed: Aug. 15, 2016

(30) Foreign Application Priority Data
Aug. 20, 2015 (DE) 10 2015 215 878.0

(51) Int. Cl. H02H 3/087; H02H 7/122; H02H 7/12

(52) U.S. Cl. CPC H02H 3/087; H02H 7/1213; H02H 7/122

(57) ABSTRACT

An apparatus and a method for protecting an electrical load, in particular an electrical load having an inductance. For this purpose, the present invention provides a protection apparatus comprising an overcurrent protection device and a protection circuit. Upon the response of the overcurrent protection device, the protection circuit enables the decrease of the electrical voltage across the overcurrent protection device and the reduction of the electrical energy stored, if appropriate, in inductances of the electrical load upon the response of the overcurrent protection device.

### BACKGROUND OF THE INVENTION

The present invention relates to a protection apparatus for an electrical load and a method for protecting an electrical load, and a circuit arrangement, in particular a voltage converter comprising a protection apparatus.

The German Patent Application DE 10 2012 200 067 A1 relates to a converter, in particular a DC/DC converter for use in a motor vehicle. The converter comprises a first disconnecting element, which is arranged between an input terminal and a converter circuit, and a second disconnecting element, which is arranged between an output terminal and the converter circuit. The converter furthermore comprises monitoring circuits for detecting a current flow into the converter circuit.

DC/DC converters are used for example in motor vehicles in order to convert electrical energy between different voltage levels. By way of example, push-pull converters in the form of full-bridge forward converters may be used for this purpose. In order to protect the components, such a DC/DC converter may have an overcurrent fuse for example on the primary side. In the event of a predefined current value being exceeded, such an overcurrent fuse can interrupt the electrical connection between an energy source and the DC/DC converter. At the time of an interruption by the overcurrent fuse, if appropriate, electrical energy may in this case be stored in a transformer and/or a further inductance of the DC/DC converter.

Therefore, there is a need for a protection apparatus for an electrical load which can switch off inductive loads in a targeted manner in the case of an overcurrent fault, without significant voltage boosts occurring in this respect. In particular, there is a need for a protection circuit which can reduce the electrical energy stored in the load in a controlled manner in the case of a fault.

### SUMMARY OF THE INVENTION

For this purpose, the present invention provides a protection apparatus for an electrical load.

Accordingly, a protection apparatus for an electrical load is provided, which comprises an overcurrent protection device and a protection circuit. The overcurrent protection device has a first terminal point and a second terminal point. In this case, the first terminal point can be connected to an electrical energy source. The second terminal point can be connected to the electrical load. The overcurrent protection device can be designed to provide an electrical connection between the first terminal point and the second terminal point. Furthermore, the overcurrent protection device can be designed to interrupt the electrical connection between the first terminal point and the second terminal point if an electric current between the first terminal point and the second terminal point exceeds a predetermined limit value. The protection circuit of the protection apparatus comprises a series circuit comprising a diode and an electrical resistor. In this case, the protection circuit is arranged between the second terminal point of the overcurrent protection device and a reference potential. In this case, the diode of the protection circuit is arranged in the reverse direction between the overcurrent protection device and the reference potential during normal operational service.

In accordance with a further aspect, the present invention provides a method for protecting an electrical load.

Accordingly, the present invention provides a method for protecting an electrical load comprising the steps of providing an overcurrent protection device comprising a first terminal point and a second terminal point, wherein the overcurrent protection device is designed to provide an electrical connection between the first terminal point and the second terminal point. The overcurrent protection device is furthermore designed to interrupt the electrical connection between the first terminal point and the second terminal point if an electric current between the first terminal point and the second terminal point exceeds a predetermined limit value. The method furthermore comprises a step for connecting a protection circuit between the second terminal point of the overcurrent protection device and a reference potential. The protection circuit comprises a series circuit comprising a diode and an electrical resistor. Furthermore, the method comprises a step for coupling the second terminal point to the electrical load. Furthermore, the first terminal point can be connected to an electrical energy source, in particular a DC voltage source, such as an electrical energy store, for example.

The present invention is based on the insight that in the case where an electrical load, in particular an inductive electrical load, is suddenly switched off, electrical energy may still be stored in said load. After the electrical load has been switched off, this stored electrical energy, if appropriate, may lead to voltage boosts.

The present invention is therefore based on the concept of reducing voltage boosts that possibly occur by means of a targeted reduction of the electrical energy in the load. For this purpose, an overcurrent protection device is extended by a further protection circuit. After the response of the overcurrent protection device, said further protection circuit provides a freewheeling path comprising a diode and an electrical ohmic resistor. After the response of the overcurrent protection device, an electric current can thus flow through a freewheeling path comprising diode and ohmic resistor. In this case, the electrical energy stored in the electrical load can be converted into thermal energy in a controlled manner in the ohmic resistor. In this way, energy from the electrical load can be reduced safely and in a controlled manner, without voltage boosts and/or other hazardous operating states being able to occur in the process.

By virtue of the reduction of the electrical energy in the freewheeling path comprising diode and resistor, in particular the voltage across the overcurrent protection device also decreases in this case. This makes it possible to ensure that the overcurrent protection device, in the case of a fault, also achieves a reliable interruption of the electrical connection between the terminals of the overcurrent protection device. Flashovers and/or breakdowns on account of voltage boosts can thus be avoided. A reliable and in particular also very fast interruption of the voltage supply by the overcurrent protection device can be ensured in this way.

In accordance with one embodiment, the diode of the protection circuit comprises a Zener diode or a suppressor diode. Moreover further components are also possible which enable a bidirectional current flow above a defined voltage threshold, while only a current flow in one direction is possible below the voltage limit. By means of such components, voltage boosts can be reduced during normal operation as well. This enables an additional protection of the electrical load.

In accordance with a further embodiment, the breakdown voltage of the diode in the reverse direction is in this case greater than an operating voltage of the electrical load. The operating voltage of the electrical load may be regarded here as the voltage with which the electrical load can maximally be operated without damage. In particular, the breakdown voltage of the diode in the reverse direction can be greater here than a nominal voltage of a voltage source by which the electrical load is fed.

In accordance with a further embodiment, the protection circuit furthermore comprises a cooling device. In this case, the cooling device can be thermally coupled to the electrical resistor and/or the diode of the protection circuit. In this case, the thermal energy generated by the electrical resistor can be dissipated rapidly and reliably by a cooling device. In this way, the energy stored in the electrical load can be reduced within a short time by the electrical resistor.

In accordance with a further embodiment, the overcurrent protection device comprises a fusible link or a circuit breaker. In particular, the circuit breaker of the overcurrent protection device can comprise a semiconductor switch for interrupting the electrical connection between the first terminal point and the second terminal point. Furthermore, the overcurrent protection device can comprise a current sensor that detects the electric current through the overcurrent protection device and, in the case where a predetermined limit value for the electric current is exceeded, opens a switching element in the overcurrent protection device in order to interrupt the electrical connection between the first terminal point and the second terminal point.

In accordance with a further aspect, the present invention provides an electrical circuit arrangement comprising a DC voltage source, an electrical load and a protection apparatus according to the invention. In this case, the first terminal point of the overcurrent protection device can be electrically coupled to the DC voltage source. The second terminal point of the overcurrent protection device can be coupled to the electrical load.

In accordance with a further embodiment, the electrical load comprises an inductance. The inductance can be an inductor core and/or a transformer, for example.

In accordance with a further aspect, the present invention provides a voltage converter comprising a protection apparatus according to the invention. In particular, the voltage converter can comprise a DC/DC converter and/or an inverter. By way of example, the voltage converter can comprise a full-bridge forward converter.

Further embodiments and advantages of the present invention are evident from the following description with reference to the accompanying drawings.

### BRIEF DESCRIPTION OF THE DRAWINGS

In the figures here:

FIG. 1 shows a schematic illustration of a circuit arrangement of an electrical load with a protection apparatus in accordance with one embodiment; and

FIG. 2 shows a schematic illustration of a flow diagram such as is taken as a basis for a method for protecting an electrical load in accordance with one embodiment.

### DETAILED DESCRIPTION

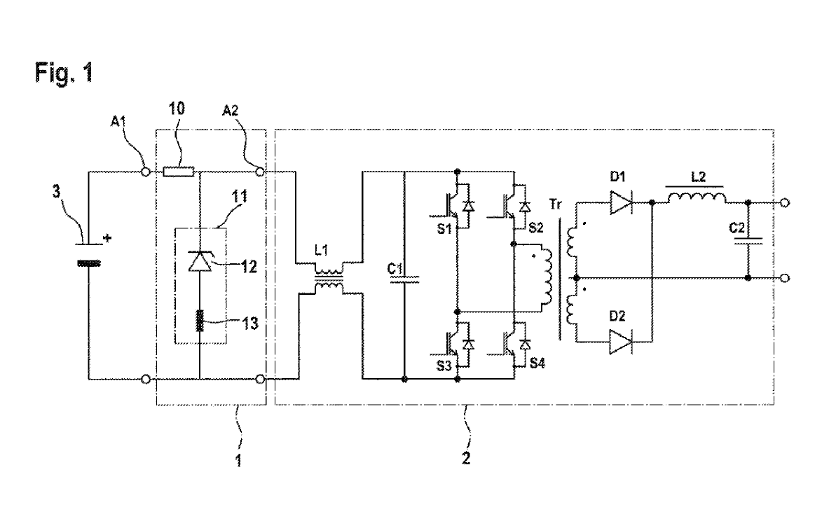

FIG. 1 shows a schematic illustration of an electrical load 2 with a protection apparatus 1 in accordance with one embodiment. In this case, the protection apparatus 1 is arranged between an electrical energy source 3 and the electrical load 2. The electrical energy source 3 can be an arbitrary DC voltage source. By way of example, an electrical energy source, such as, for example, a battery or the like, is possible as the electrical energy source 3. Moreover, other DC voltage sources are also possible, however, such as, for example, a photovoltaic installation or the like.

One terminal of the electrical energy source 3 is connected to a first terminal point A1 of the protection apparatus 1. The other terminal of the electrical energy source 3 is connected to a reference potential. In the exemplary embodiment illustrated here, the positive terminal of the electrical energy source 3 is connected to the first terminal point A1 and the negative terminal of the electrical energy source 3 is connected to the reference potential. Alternatively, however, it is likewise possible for the negative terminal of the electrical energy source 3 to be connected to the first terminal point A1 of the protection apparatus 1 and for the positive terminal of the electrical energy source 3 to be connected to the reference potential.

Furthermore, a second terminal point A2 of the protection apparatus 1 is connected to one terminal of the electrical load 2. A further terminal of the electrical load 2 is connected to the reference potential. The two aforementioned terminals of the electrical load 2 here constitute the terminals for feeding electrical energy into the electrical load 2. The protection apparatus 1 is thus arranged between the energy source 3 and the load 2.

The electrical load 2 can be an arbitrary electrical load, in principle. In particular, the electrical load 2 can comprise at least one inductive component. By way of example, the electrical load 2 can be a voltage converter. Such a voltage converter converts a DC voltage present at the two above-described terminals of the electrical load 2 into a further DC or AC voltage and provides the latter at an output. In the exemplary embodiment illustrated in FIG. 1, the electrical load 2 is a DC/DC converter, for example. However, the present invention is not restricted to such a DC/DC converter. Rather, the electrical load 2 can also be an electrical load in the form of an inverter or a combined inverter-DC/DC converter.

The DC/DC converter in accordance with the embodiment illustrated here in this case comprises firstly an input inductor L1 at the input side with the two input terminals. Downstream of the input inductor L1, a first capacitor C1 is arranged between the two terminals of the input inductor. The input voltage is subsequently fed to a full-bridge forward converter. Said full-bridge forward converter comprises the four switching elements S1, S2, S3 and S4, and also the transformer Tr and the two diodes D1 and D2. Furthermore, the full-bridge forward converter can also comprise a further inductance L2 and a smoothing capacitor C2 on the output side. In this case, the switching elements S1 to S4 of the full-bridge forward converter are driven by a control device (not illustrated here), such as, for example, a microcontroller or the like.

The protection apparatus 1 between the energy source 3 and the load 2 comprises an overcurrent protection device 10 between the first terminal point A1 and the second terminal point A2. Said overcurrent protection device firstly provides an electrically conductive connection between the first terminal point A1 and the second terminal point A2. If the electric current between the first terminal point A1 and the second terminal point A2 exceeds a predefined limit value, then the overcurrent protection device 10 interrupts the electrical connection between the first terminal point A1 and the second terminal point A2. Said overcurrent protection device can be for example a fusible link or the like. Furthermore, reversible overcurrent protection devices 10 are also possible. In particular, the overcurrent protection device 10 can also be an electrical switching element that is initially closed during operation. If a current that exceeds a predefined limit value is detected between the first terminal point A1 and the second terminal point A2 for example by a current sensor or the like, then said switching element can be opened by means of a suitable driving. In particular, relays or semiconductor switching elements are possible as switching elements of the overcurrent protection device 10.

Furthermore, the protection apparatus 1 comprises a protection circuit 11 comprising a diode 12 and an electrical resistor 13. In this case, the protection circuit 11 is arranged between the second terminal point A2 and the reference potential. The diode 12 and the electrical resistor 13 are connected in series with one another. In this case, the diode 12 is arranged such that in the case of normal operation, that is to say in the case of an electrical connection in the overcurrent protection device 10 between the first terminal point A1 and the second terminal point A2 and thus in the case of an applied voltage by means of the energy source 3, the diode 12 is operated in the reverse direction.

The electrical resistor 13 can be an ohmic resistor dimensioned with a sufficiently high resistance. The dimensioning of the resistor 13 is explained in even greater detail below. Since electrical energy is converted into thermal energy in the event of a current flow through the electrical resistor 13, said thermal energy must be able to be dissipated. For this purpose, the protection apparatus 1 can comprise a suitable cooling device (not illustrated here). In particular, the cooling device can be thermally coupled to the electrical resistor 13 and, if appropriate, also to the diode 12. The cooling device can be for example a passive heat sink. In principle, however, an active cooling by means of a liquid or gaseous cooling medium is also possible. In particular, by way of example, a fan or the like is possible for an active cooling capacity.

If a fault occurs in the electrical load 2, then an inductance, such as the transformer Tr, for example, may attain saturation in the electrical load 2. Such a state can occur, for example, if, in the full-bridge forward converter illustrated here, the corresponding switching elements S1 to S4 are not clocked correctly and a high current through the primary side of the transformer Tr is thereupon established. In such a fault situation, the overcurrent protection device 10, on account of a high current through the overcurrent protection device 10, can interrupt the electrical connection between the first terminal point A1 and the second terminal point A2. By way of example, for this purpose, a switching element in the overcurrent protection device 10 can be opened or a fusible link can blow. The electrical connection between the energy source 3 and the load 2 is thereupon interrupted.

On account of the high current through the inductive components of the load 2 at the time of the response of the overcurrent protection device 10, without the protection circuit 11 a high voltage can thereupon be established at the second terminal point A2 and thus also between the first terminal point A1 and the second terminal point A2. Said voltage could thereupon lead to a malfunction of the overcurrent protection device 10, as a result of which the electrical connection between the first terminal point A1 and the second terminal point A2 would not be interrupted or would at least not be completely interrupted. Such overvoltages can be counteracted by the protection circuit 11. If a voltage is induced after the response of the overcurrent protection device 10 on account of the inductances in the electrical load 2, then said voltage can flow through the diode 12 and the resistor 13 of the protection circuit 11. As a result, firstly the voltage at the second terminal point A2 is decreased. Consequently, the voltage between the first terminal point A1 and the second terminal point A2 also decreases during the response of the overcurrent protection device 10 and the overcurrent protection device 10 can reliably disconnect the electrical connection between the first terminal point A1 and the second terminal point A2. Furthermore, the electrical energy stored in the inductances, such as, for example, the inductor L1 and the transformer Tr, will be reduced in the protection circuit 11, and here in particular by means of the electrical resistor 13, and be converted into thermal energy.

For converting the electrical energy from the load 2 into thermal energy at the resistor 13 as rapidly as possible, the resistor 13 should be chosen to have the highest possible resistance. On the other hand, a resistor 13 having a high resistance leads to a high voltage spike in the event of the overcurrent protection device 10 being triggered. Furthermore, in this case, the protection circuit 11 must also be designed such that the thermal energy generated by the electrical resistor 13 can also be dissipated sufficiently. For this purpose, a sufficient cooling capacity must be present at the electrical resistor 13. In this case, the thermal energy Pₜₕₑᵣₘₐₗ generated by the electrical resistor 13 results from the electric current I_{fault} in the case of a fault and ohmic resistance R of the resistor 13 as:

Pₜₕₑᵣₘₐₗ=I²_{fault}·R

In this case, the maximum overcurrent upon the response of the overcurrent protection device 10 can be assumed for example to be five times the rated current of the overcurrent protection device 10. In this case, the current through the protection circuit 11 and thus also through the electrical resistor 13 decays exponentially after the response of the overcurrent protection device 10, wherein the current through the protection circuit 11 initially corresponds to the current upon the response of the overcurrent protection device. The dimension of the resistor 13 can thus be determined from the maximum cooling capacity of the resistor 13 and the expected current upon the response of the overcurrent protection device.

For a reliable protection by the protection apparatus 1 described above, in this case the protection circuit 11 should be arranged as near as possible to the second terminal point A2 of the overcurrent protection device 10. In this way, in particular, effects on account of parasitic inductances in the lines can also be eliminated or reduced. For reducing the electrical energy stored in the electrical load 3 as rapidly as possible, the electrical resistor 13 of the protection circuit 11 can be dimensioned with the highest possible resistance. On the other hand, a smaller dimensioning of the electrical resistor 13 makes it possible to reduce the voltage between the second terminal point A2 and the reference potential upon the response of the overcurrent protection device 10. Consequently, by reducing the resistance of the resistor 13 in the protection circuit 11, it is also possible to choose an overcurrent protection device 10 having a lower maximum dielectric strength, since the voltage between the first terminal point A1 and the second terminal point A2 upon the opening of the overcurrent protection device 10 will also be lower in this case.

For the above-described reduction of the electrical energy from the load 2 upon the response of the overcurrent protection device 10, a conventional diode, in particular a semiconductor diode, is sufficient here. Moreover, with the use of specific diodes, such as, for example, Zener diodes or suppressor diodes, an additional overcurrent protection also results during normal operational service. Since the diode 12 is arranged in the reverse direction between the second terminal point A2 and the reference potential during normal operation, no current will flow through the protection device 10 in this case. Overvoltages possibly occurring from the energy source 3 can be reduced by the use of Zener diodes or other components which conduct out electric current above a defined voltage in the reverse direction as well. In this case, the breakdown voltage in the reverse direction of the diode 12 should be above the operating voltage of the electrical load 2 or the voltage provided by the energy source 3. If appropriate, the required breakdown voltage or dielectric strength can also be achieved by connecting a plurality of (Zener) diodes in series.

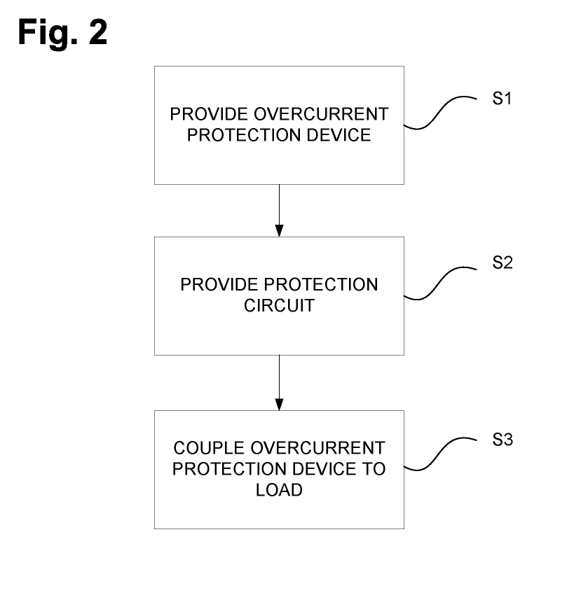

FIG. 2 shows a schematic illustration of a flow diagram such as is taken as a basis for a method for protecting an electrical load in accordance with one embodiment. Step S1 involves firstly providing an overcurrent protection device having a first terminal point A1 and a second terminal point A2. In this case, the overcurrent protection device 10 is designed to interrupt an electrical connection between the first terminal point A1 and the second terminal point A2 if an electric current between the first terminal point A1 and the second terminal point A2 exceeds a predetermined limit value. Step S2 involves providing a protection circuit 11 comprising a series circuit comprising a diode 12 and an electrical resistor 13. Said protection circuit is connected to the second terminal point A2 of the overcurrent protection device on one side and to a reference potential on the other side. Furthermore, step S3 involves coupling the second terminal point A2 to the electrical load 3.

To summarize, the present invention relates to the protection of an electrical load, in particular an electrical load having an inductance. For this purpose, the present invention provides a protection apparatus comprising an overcurrent protection device and a protection circuit. Upon the response of the overcurrent protection device, the protection circuit enables the decrease of the electrical voltage across the overcurrent protection device and the reduction of the electrical energy stored, if appropriate, in inductances of the electrical load 3 upon the response of the overcurrent protection device.

1. A protection apparatus (1) for an electrical load (2), comprising:
an overcurrent protection device (10), having a first terminal point (A1) and a second terminal point (A2), wherein the second terminal point (A2) is connected to the electrical load (2), and wherein the overcurrent protection device (10) is configured to interrupt an electrical connection between the first terminal point (A1) and the second terminal point (A2) if an electric current between the first terminal point (A1) and the second terminal point (A2) exceeds a predetermined limit value; and
a protection circuit (11), arranged between the second terminal point (A2) of the overcurrent protection device (10) and a reference potential, and the protection circuit (11) including a series circuit comprising a diode (12) and an electrical resistor (13).

2. The protection apparatus (1) according to claim 1, wherein the diode (12) is a Zener diode or a suppressor diode.

3. The protection apparatus (1) according to claim 2, wherein the breakdown voltage of the diode (12) in the reverse direction is greater than an operating voltage of the electrical load (2).

4. The protection apparatus (1) according to claim 1, wherein the protection circuit (11) includes a cooling device thermally coupled to the electrical resistor (13).

5. The protection apparatus (1) according to claim 1, wherein the overcurrent protection device (10) is a fusible link or a circuit breaker.

6. An electrical circuit arrangement, comprising:
a DC voltage source (3);
an electrical load (2); and
a protection apparatus (1) according to claim 1; wherein the first terminal point (A1) of the overcurrent protection device (10) is electrically coupled to the DC voltage source (3) and the second terminal point (A2) of the overcurrent protection device (10) is electrically coupled to the electrical load (2).

7. The electrical circuit arrangement according to claim 6, wherein the electrical load (2) includes an inductance.

8. A voltage converter, comprising a protection apparatus (1) according to claim 1.

9. The voltage converter according to claim 8, wherein the voltage converter is a DC/DC converter.

10. The voltage converter according to claim 8, wherein the voltage converter is an inverter.

11. A method for protecting an electrical load (2), the method comprising:
providing (S1) an overcurrent protection device (10), having a first terminal point (A1) and a second terminal point (A2), the overcurrent protection device (10) configured to interrupt an electrical connection between the first terminal point (A1) and the second terminal point (A2) if an electric current between the first terminal point (A1) and the second terminal point (A2) exceeds a predetermined limit value;
connecting (S2) a protection circuit (11) having a series circuit including a diode (12) and an electrical resistor (13) between the second terminal point (A2) of the overcurrent protection device (10) and a reference potential;
coupling (S3) the second terminal point (A2) to the electrical load (2).
